(19) United States
(12) Patent Application Publication
(10) Pub. No.: US 2012/0310385 A1
(43) Pub. Date: Dec. 6, 2012

(54) DEVICE FOR ASCERTAINING CONTROL UNIT PARAMETERS

(76) Inventors: Markus Bossler, Fellbach (DE); Maximilian Reger, Stuttgart (DE)

(21) Appl. No.: 13/515,461

(22) PCT Filed: Dec. 2, 2010
(86) PCT No.: PCT/EP10/68757

§ 371 Date: Aug. 24, 2012

(30) Foreign Application Priority Data
Dec. 17, 2009 (DE) 10 2009 054 900.5

(51) Int. Cl. G05B 15/00

(52) U.S. Cl. 700/83

(57) ABSTRACT

A device for ascertaining control unit parameters has a user interface, using which, target variables are able to be selected, and a memory unit in which at least one set of optimal parameters is stored, there being an association between the target variables to be selected and the at least one set of optimal parameters.

### BACKGROUND OF THE INVENTION

1. Field of the Invention

The present invention relates to a device and a method for ascertaining control unit parameters.

2. Description of the Related Art

In the field of control unit application or control unit data mining, the properties and the response of the vehicle system are provided by user data and application data. These user parameters, which are also designated as control unit parameters, thus affect the driving behavior of the vehicle, since these define the functions of the control unit and, with that, the way of functioning of the control unit.

The above-mentioned control unit functions offer the possibility of determining fixed settings, using a set of parameters, and in many cases also using a plurality of sets of parameters, via constants, characteristics curves and characteristics maps. One should note in this context that the complexity of the functions, and consequently also the number of characteristics maps, is increasing steadily. Function specialists, who in the most favorable case know the effect of each parameter, are thus able to design the functions according to the requirements of the customer.

The complexities of the functions and consequently also the number of functional parameters rise with increasing requirements on the system. At the same time, however, the customer requires a simplification of the structures, since a complex software structure is only able to be handled using expert knowledge, and is difficult to apply.

Furthermore, it should be noted that a specific behavior, such as the driving behavior, is able to be set by very many control unit parameters. In addition, the control unit parameters and the functional parameters, which are responsible for a desired behavior, are able to influence one another.

It is customary at this time to change the individual functional parameters of a control unit function directly. In this procedure, the quality is a function of the experience of the applicator. In this context, as a rule, one proceeds according to the stipulation of a document. Within the scope of the application, the target is ascertained by a plurality of iterations, and thus, for instance, by measuring, valuation and changing. In order to represent various behavioral ways, at this time, two, and in a few cases more, different sets of functional parameters may be stored in the control unit.

For the user of the system controlled by the control unit, such as the driver of a vehicle, in which the control unit becomes utilized using the functions affected by the set parameters, the functions and the parameters influencing them are hardly understandable. Furthermore, one should note that the complexity of the functions, and consequently also the number of functional parameters having increasing requirements, are increasing.

### BRIEF SUMMARY OF THE INVENTION

Consequently, it is provided that one should design control unit functions according to requirements, such as target variables and/or valuation criteria, of the manufacturer and the end customer, via functional parameters. Target variables, in this context, refer to a desired behavior of the motor vehicle, for instance, with regard to driving convenience and the dynamics. As functional parameters for this, time constants, reinforcement factors and thresholds are used, for example. For the behavior with respect to emissions, power and fuel consumption, one may use as functional parameters the injection pressure, the rail pressure, the exhaust-gas recirculation and the valve setting, or they are derived from it.

In the embodiment it is possible for the user to specify the desired behavior via a weighting or via weightings of target variables.

Consequently, using the methods provided, an abstraction of the individual functional parameters of a control unit function is carried out. By this abstraction, the functional parameters are then no longer set by the operator, but rather the behavior that is to be influenced by the function. In this way it is possible, in the case of a driving behavior application, to set the vehicle behavior almost continuously using a man-machine interface. For this, one may use, for example, a sliding controller (slider) of a man-machine interface or a GUI (GUI: graphical user interface). The actual functional parameters are set by an algorithm based on the slider positions. Alternatively, one could also use a rotational controller or rotating button or other devices that permit a continuous adjustment.

One possible embodiment, or broadening of this approach, provides that this almost continuous possibility of adjustment should be offered to the end customer as a vehicle performance feature. The data required may be provided by a separately available memory medium, such as an USB, DVD, SD etc.

Using the method described, one is able to achieve an application of the functional parameters and the control unit parameters that is simpler, compared to known procedures. In addition, a uniform, high quality of the application is assured. An exact knowledge of limitations and possibilities of the system prevails, especially when only optimal parameters are used. Furthermore, the possibility exists that the OEM or the end customer is able to set the behavior himself, at least within certain limits.

In the embodiment of the method it is possible, in a so-called statistical experimental planning (DoE: Design of Experiments) to ascertain the sets of optimal parameters. These changes are carried out with the aid of experimental/measuring automation, and plotted. The experimental results are evaluated based on specific evaluation criteria. It should be noted that the relationship between the application parameters and the evaluation criteria may be illustrated in a model. Using this model, a multi-criterion optimization task may be carried out with regard to the evaluation criteria. As a result, a series of optimal application data sets are obtained, which may be set, for instance, by using sliders in a GUI.

However, it is also basically possible to ascertain the parameters using other methods. The parameters may also be ascertained, for example, by an optimization on a physical model, or by an online optimization on the real system. The parameter sets may be stored in a so-called model of optimal parameters.

To provide a model of optimal parameters, ahead of time, directly on the system or on a behavioral model of the system (corresponds to a criteria model), a multi-target optimization is carried out via all essential operating points, using an optimizer, on all necessary target variables and/or criteria, using the available functional parameters. The results obtained from the optimization then include, for each operating point, the optimized functional parameters for all compromises of the target variables and/or criteria.

From the results obtained from the optimization, an operating point-dependent model of optimal parameters may then be set up. This may be done in the form of characteristics maps and multi-dimensional data models. The inputs of the model are the operating points and the target variables and/or criteria, or their weighting, and with that, the weighting of the target variables/criteria.

The simplest form of the representation of optimal parameters takes place via a list, in which the optimization results are stored via the operating points and via various compromises of the evaluation criteria.

Using the device provided, the selection of a desired behavior may take place very rapidly and comfortably. In addition, the procedure may be applied to many application tasks. The know-how and knowledge of the control unit function and the application knowledge are able to be brought together compactly in this procedure. The customer, such as the OEM or the end customer, is able to set the behavior in a simple manner himself.

Additional advantages and developments of the present invention result from he specification and the appended figures.

It is understood that the features mentioned above and the features yet to be described below may be used not only in the combination given in each case but also in other combinations or individually, without departing from the scope of the present invention.

### BRIEF DESCRIPTION OF THE DRAWINGS

FIG. 1 shows a procedure for ascertaining optimal parameters using statistical experimental planning.

FIG. 2 shows the procedure of FIG. 1, emphasizing a criterion-related application.

FIG. 3 schematically depicts a specific embodiment of the device described.

### DETAILED DESCRIPTION OF THE INVENTION

The present invention is represented schematically in the figures based on specific embodiments, and is described in detail below with reference to the figures.

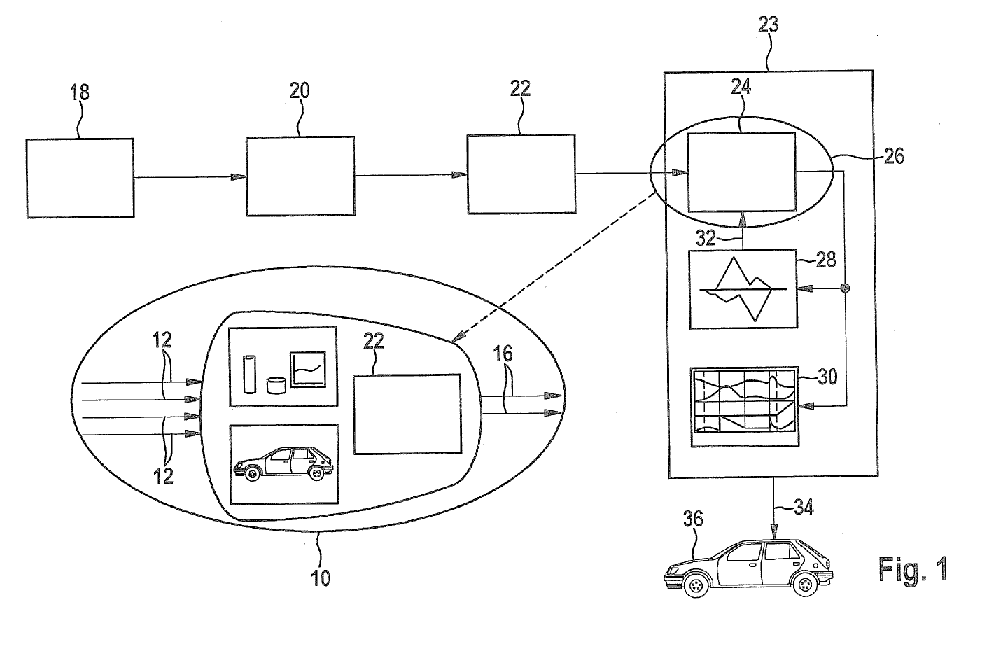

FIG. 1 shows a behavioral model or a parameter-criteria model 10, into which control unit parameters 12 are entered which are interpreted in model 10 using an interpreter 22, so that criteria Fₛ and Tₛ are yielded.

In a statistical experimental planning 18 (DoE), it is specified which parameter variations or parameter combinations are meaningful at which operating points. Using a measuring automation 20, one then carries out the parameters and operating point variations specified in experimental plan 18 on the system.

Upon the system response, for each parameter variation and operating point variation, the criteria, that are necessary for the judgment of the system, are computed in interpreter 22. These processes may be of a statistical as well as of a dynamic nature.

In one additional tool 23, a behavior model or data model 24 is set up. Within tool 23, an optimizer 28 is able to optimize, and the results are able to be displayed or visualized using a visualizer 30. Based on these data, behavioral model 24 of the system may be computed.

Optimized control unit parameters 34 are then provided to an application 36, in this case a motor vehicle.

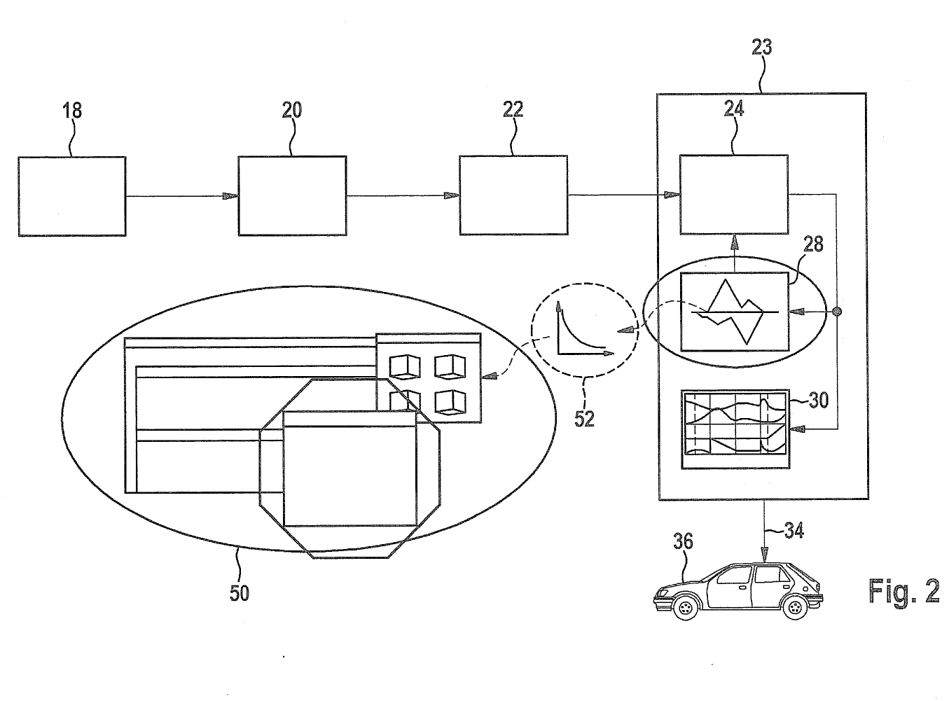

In FIG. 2 a representation comparable to FIG. 1 of the ascertainment of optimal parameters is given, using a DoE experimental plan. In this representation, a criteria-related application 50 is shown, which works based on optimal parameters and on target conflict 52 between the valuation criteria, such as dynamics vs. comfort. The optimal parameters and the target conflict between the criteria are results of optimizer 28. One is able to select a compromise in the target conflict via a user surface. The corresponding parameters are stored, and are set in the control unit.

Consequently, in this embodiment, control unit parameters and application parameters 12 are changed using statistical experimental plan (DoE) 18. These changes are carried out with the aid of experimental/measuring automation 20, and are plotted. The experimental results yielded are then evaluated with the aid of specific evaluation criteria. A relationship between control unit parameters 12 and the evaluation criteria is illustrated in a model 24. Using this model 24, a multi-criterion optimization may be carried out while taking into account the evaluation criteria. A series of optimal application data sets is yielded, which are able to be set almost continually by using a user interface.

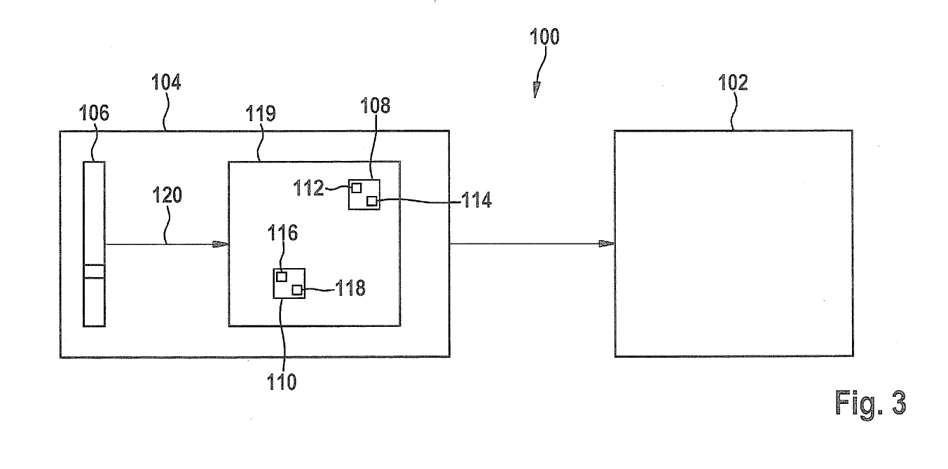

FIG. 3, in a schematic representation, shows a specific embodiment of the device for ascertaining functional parameters, which overall has been denoted by reference numeral 100. This device 100 may be implemented by a computer program, for example, which is able to be carried out within a control unit software.

Device 100 is connected to a control unit 102, and has a user surface 104, on which a user interface 106 is provided, which is developed as a graphic user interface in the form of a slider.

Using this user interface 106, target variables, which relate to the behavior of a vehicle, or even weightings of target variables may be specified by the user.

The target variables to be selected and the weightings of target variables are associated with sets 108 and 110 of parameters 112 and 114 or 116 and 118, which are stored in a memory 119.

Depending on the association (arrow 120), set 108 or 110 having the included parameters 112, 114, 116, 118 is referred to the specified target variables, which is usually optimal for achieving the desired behavior. These parameters 112, 114 or 116, 118 are then set in control unit 102.

1-10. (canceled)

11. A device for ascertaining control unit parameters for a control unit for controlling a technical system, comprising:
a user interface by which target variables are selected; and
a memory unit storing at least one set of optimal parameters, wherein an association is provided between the target variables selected and the at least one set of optimal parameters.

12. The device as recited in claim 11, wherein a weighting of target variables is selected.

13. The device as recited in claim 12, wherein the user interface is a graphic user interface.

14. The device as recited in claim 12, wherein the user interface is a sliding controller of a machine.

15. The device as recited in claim 12, wherein the at least one set of optimal parameters is provided in a model of optimal parameters.

16. A method for ascertaining control unit parameters for a control unit for controlling a technical system, comprising:
selecting, using a user interface of the control unit, target variables; and
providing an assignment of the selected target variables to at least one set of optimal parameters.

17. The method as recited in claim 16, further comprising:
selecting a weighting of the target variables.

18. The method as recited in claim 17, a wherein the at least one set of optimal parameters is provided in a model of optimal parameters.

19. The method as recited in claim 17, wherein the at least one set of optimal parameters is provided with evaluation criteria.
